(19) United States
(12) Patent Application Publication
(10) Pub. No.: US 2023/0142822 A1
(43) Pub. Date: May 11, 2023

(54) INTELLIGENT ELECTRONIC DEVICE AND METHOD THEREOF

(71) Applicant: Accuenergy (Canada) Inc., Toronto (CA)

(72) Inventors: Ketao Li, Toronto (CA); Guanghao Yu, Toronto (CA); Junhui Wang, Toronto (CA); Haoliang Deng, Toronto (CA); Linxuan Chen, Toronto (CA); Xiao Wu, Toronto (CA); Kehao Si, Toronto (CA); Wenbing Tan, Toronto (CA); Yan Ding, Toronto (CA); Changcheng Hao, Toronto (CA); Alex Yeh, Toronto (CA); Liang Wang, Toronto (CA); Liwei Wang, Toronto (CA); Tao Xu, Toronto (CA); Shiheng Deng, Toronto (CA); Shaohang Cui, Toronto (CA); Youwei Zhang, Toronto (CA); Yufan Wang, Toronto (CA); Zihao Chen, Toronto (CA)

(21) Appl. No.: 17/524,670

(22) Filed: Nov. 11, 2021

(51) Int. Cl. H02J 3/00

(52) U.S. Cl. CPC H02J 3/002; H02J 3/003

(57) ABSTRACT

A method and apparatus measures flicker while improving the computational performance for measuring flicker severity level. Specifically, an Intelligent Electronic Device employs a method in which a processor summarizes and characterizes a plurality of instantaneous flicker sensation level values as histogram formatted data and selects a specific percentile of the instantaneous flicker sensation level values from the histogram formatted data. The method employed by the device uses the specific percentile to calculate a short-term flicker severity level value.

### FIELD OF THE INVENTION

The present disclosure generally relates to the field of Intelligent Electronic Devices for electrical utility services and, more specifically, to digital electrical power and energy meters for use in performing electrical utility services.

### BACKGROUND

Monitoring electrical energy is a fundamental function within any electrical power distribution system. Electrical energy may be monitored to determine usage and power quality. A device that monitors electrical energy may be an Intelligent Electronic Device (IED).

With the growth of wind power, flickers are becoming an increasingly important power quality parameter. Any variability of voltage within the electrical power distribution system can cause variability of electrical lighting. If such variability is visible to the human eye, the voltage variation is called “flicker.” The International Electrotechnical Commission (IEC) issued a standard, IEC 61000-4-15, that defines a Flickermeter's functional and design specifications. In this standard, percentiles are used for short-term evaluation. In the IED, a sorting algorithm, such as quicksort, is used to obtain the percentiles. However, the average performance of quicksort it is unsatisfactory under some conditions.

Therefore, further improvements to Intelligent Electronic Devices would be desirable.

### SUMMARY OF THE INVENTION

The embodiments of the present disclosure generally related to method and apparatus for measuring flicker within any electrical power distribution system.

In some embodiments, the present disclosure provides an intelligent electronic device (IED). The IED includes at least one sensor configured for sensing at least one electrical parameter of electrical power distributed from an electrical distribution system to a load; at least one analog-to-digital converter coupled to the at least one sensor and configured for converting an analog signal output from the at least one sensor to digital data; at least one processing module coupled to the at least one analog-to-digital converter and to non-transitory memory storing instructions that when executed cause the at least one processing module to receive the digital data; obtain a plurality of instantaneous flicker sensation level values based on the digital data; summarize and characterize a plurality of instantaneous flicker sensation level values as histogram formatted data; select a specific percentile of the instantaneous flicker sensation level values from the histogram formatted data; means for calculating a short-term flicker severity level value according to the specific percentile.

In some other embodiments, the present disclosure provides a method for estimating a flicker severity in an electrical power distribution system. The method includes accumulating a plurality of instantaneous flicker sensation level values; summarizing and characterizing the plurality of instantaneous flicker sensation level values as histogram formatted data; selecting a specific percentile of the instantaneous flicker sensation level values from the histogram formatted data; calculating a short-term flicker severity level value according to the specific percentile.

These and other features and aspects of the present disclosure will become fully apparent from the following detailed description of exemplary embodiments, the appended claims and the accompanying drawings.

### BRIEF DESCRIPTION OF THE DRAWINGS

FIG. 1 is a block diagram of an exemplary Intelligent Electronic Device.

FIG. 2 is a block diagram of a Flickermeter based on modeling of the lamp-eye-brain chain.

FIG. 3 is a flow chart illustrating a method of estimating the severity of flicker within an electrical power distribution system.

FIG. 4 is another flow chart illustrating an example method of estimating the severity of flicker within an electrical power distribution system.

### DETAILED DESCRIPTION

Embodiments of the present disclosure will be described herein with reference to the accompanying drawings. In the following descriptions, well-known functions or constructions are not described in detail to avoid obscuring the present disclosure. The word “exemplary” is used herein to mean “serving as an example.” Any configuration or design described herein as “exemplary” is not to be constructed as preferred, or advantageous, over other configurations or designs. Herein the phrase “coupled” is defined as “directly connected to or indirectly connected with” one or more intermediate components. Such intermediate components may include both hardware and software-based components.

It is further noted that, unless otherwise indicated, all functions described herein may be implemented in either software, hardware, or some combination thereof.

It should be recognized that the present disclosure can be performed in numerous ways, including as a process, an apparatus, a system, a method, or a computer-readable medium such as a computer storage medium.

As used herein, Intelligent Electronic Devices (“IEDs”) can be any device that senses electrical parameters and computes data including, but not limited to, Programmable Logic Controllers (“PLCs”), Remote Terminal Units (“RTUs”), electrical power meters, protective relays, fault recorders, phase measurement units, and other devices which are coupled with power distribution networks to control and manage the distribution or consumption of electrical power.

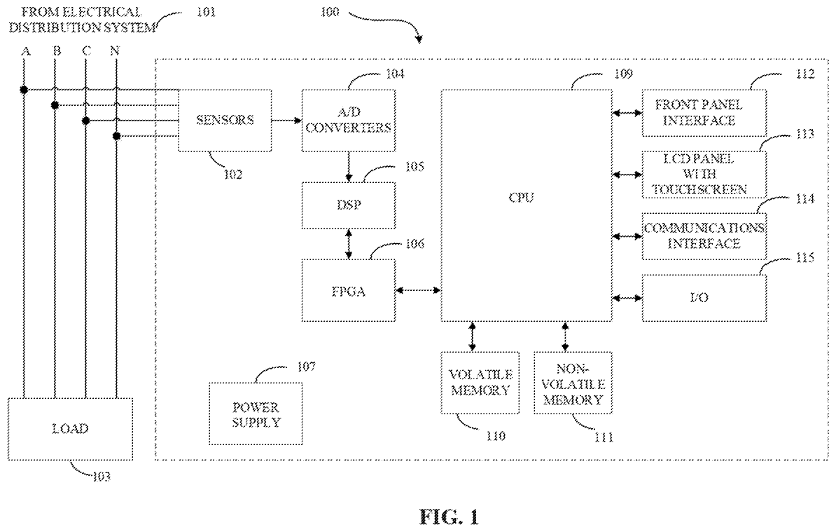

FIG. 1 is a block diagram of an Intelligent Electronic Device (IED)100 for monitoring power usage and power quality for any metered point within a power distribution system.

The IED 100 illustrated in FIG. 1 includes multiple sensors 102 coupled with various phases A, B, C, and N (neutral) of an electrical distribution system 101, multiple analog-to-digital (A/D) converters 104, a power supply 107, volatile memory 110, non-volatile memory 111, a front panel interface 112, and a processing module that includes at least one Central Processing Unit (CPU) and/or one or more Digital Signal Processors (DSP), two of which are shown DSP 105 and CPU 109. The IED 100 also includes a Field Programmable Gate Array (FPGA) 106 which performs several functions, including acting as a communications bridge for transferring data between the various processors (105 and 109).

The sensors 102 sense electrical parameters, such as voltage and current, on incoming lines (phase A, phase B, phase C, and neutral N) of an electrical power distribution system 101 that are coupled to at least one load 103 that consumes the provided power. In one embodiment, the sensors 102 include current transformers and potential transformers, where one current transformer and one voltage transformer will be coupled to each phase of the incoming power lines. The primary winding of each transformer will be coupled to the incoming power lines and the secondary winding of each transformer will output a voltage representative of the sensed voltage and current. The output of each transformer will be coupled with the A/D converters 104 which are configured to convert the analog voltage output from the transformer to a digital signal that can be processed by the DSP 105.

A/D converters 104 are configured to convert an analog voltage output to a digital signal that is transmitted to a gate array, such as Field Programmable Gate Array (FPGA) 106. The digital signal is then transmitted from the FPGA 106 to the CPU 109.

The CPU 109 or DSP Processors 105 are configured to receive digital signals from the A/D converters 104 and perform the necessary calculations to determine power usage and control the overall operations of the IED 100. In some embodiments, the CPU 109 and DSP 105 may be combined into a single processor to serve the functions of each component. In some embodiments, it is contemplated to use an Erasable Programmable Logic Device (EPLD), a Complex Programmable Logic Device (CPLD), or any other programmable logic device in place of the FPGA 106. In some embodiments, the digital samples, which are output from the A/D converters 104 are sent directly to the CPU 109, effectively bypassing the DSP 105 and the FPGA 106 as a communications gateway.

The power supply 107 provides power to each component of the IED 100. In one embodiment, the power supply 107 is a transformer with its primary windings coupled to the incoming power distribution lines to provide a nominal voltage at its secondary windings. In other embodiments, power may be supplied from an independent power source to the power supply 107.

In FIG. 1, the front panel interface 112 is shown coupled to the CPU 109 which includes indicators, switches, and various inputs.

In FIG. 1, the LCD panel with touchscreen 113 is shown coupled to the CPU 150 for interacting with a user and for communicating events, such as alarms and instructions. The LCD panel with touchscreen 113 may provide information to the user in the form of alpha-numeric lines, computer-generated graphics, videos, animations, etc.

An input/output (I/O) interface 115 may be provided for receiving externally generated inputs from the IED 100 and for outputting data, such as serial data, to other devices. In one embodiment, the I/O interface 115 may include a connector for receiving various cards and/or modules that increase and/or change the functionality of the IED 100.

The IED 100 also includes volatile memory 110 and non-volatile memory 111. The volatile memory 110 will store the sensed and generated data for further processing and for retrieval when requested to be displayed at the IED 100 or from a remote location. The volatile memory 110 includes internal storage memory, such as Random-Access Memory (RAM). The non-volatile memory 111 includes removable memory, such as magnetic storage memory, optical storage memory (such as various types of CD or DVD media), solid-state storage memory, (such as a CompactFlash card, a Memory Stick, SmartMedia card, MultiMediaCard [MMC], SD [Secure Digital] memory), or any other memory storage that exists currently or will exist in the future. Such memory will be used for storing historical trends, waveform captures, event logs (including timestamps), and stored digital samples for later download to a client application, webserver, or PC application.

In a further embodiment, the IED 100 will include a communication interface 114, also know as a network interface, for enabling communications between the IED, or meter, and a remote terminal unit or programmable logic controller and other computing devices, microprocessors, desktop computers, laptop computers, other meter modules, etc. The communication interface 114 may be a modem, Network Interface Card (NIC), wireless transceiver, or other interface. The communication interface 114 will operate with hardwired and/or wireless connectivity. A hardwired connection may include, but is not limited to, physical cabling (such as parallel cables serial cables, RS232, RS485, USB cables, or Ethernet) and an appropriately configured communication port. The wireless connection may operate under any of the various wireless protocols including, but not limited to, Bluetooth™ interconnectivity, infrared connectivity, radio transmission connectivity (including computer digital signal broadcasting and reception commonly referred to as Wi-Fi or 802.11.X [where x denotes the type of transmission]), satellite transmission, or any other type of communication protocols, communication architecture, or systems currently existing or to be developed for wirelessly transmitting data.

The IED 100 may communicate to a server or other computing device via the communication interface 114. The IED 100 may be connected to a communications network (such as the Internet) by any means. For example, a hardwired or wireless connection, such as dial-up, hardwired, cable, DSL, satellite, cellular, PCS, or wireless transmission (e.g., 802.11 a/b/g) may be used. It is noted that the network may be a Local Area Network (LAN), Wide Area Network (WAN), the Internet, or any network that couples multiple computers to enable various modes of communication via network messages. Furthermore, the server will communicate using various protocols, such as Transmission Control Protocol/Internet Protocol (TCP/IP), File Transfer Protocol (FTP), or Hypertext Transfer Protocol (HTTP) or via secure protocols such as Hypertext Transfer Protocol Secure (HTTPS), Internet Protocol Security Protocol (IPSec), Point-to-Point Tunneling Protocol (PPTP), Secure Sockets Layer (SSL) Protocol, or via other secure protocols. The server may further include a storage medium for storing the data received from at least one IED or meter and/or storing data to be retrieved by the IED or meter.

In an additional embodiment, when a power event occurs, such as a voltage surge, voltage sag, or current short circuit, the IED 100 may also have the capability of not only digitizing waveforms but storing the waveform and transferring that data upstream to a central computer, such as a remote server. The power event may be captured, stored to memory (e.g., non-volatile RAM), and additionally transferred to a host computer within the existing communication infrastructure either immediately, in response to a request from a remote device or computer, or later in response to a polled request. The digitized waveform will also allow the CPU 109 to compute other electrical parameters such as harmonics, magnitudes, symmetrical components, and phasor analysis.

In a further embodiment, the IED 100 will execute an e-mail client and will send notification e-mails to the utility or directly to the customer when a power quality event occurs. This allows utility companies to dispatch crews to repair the condition. The data generated by the meters is used to diagnose the cause of the condition. The data is transferred through the infrastructure created by the electrical power distribution system. The e-mail client will utilize POP3 or another standard e-mail protocol.

The techniques of the present disclosure can be used to automatically maintain program data and provide field-wide updates upon which IED firmware and/or software can be upgraded.

An event command can be issued by a user, on a schedule, or through a digital communication that will trigger the IED 100 to access a remote server and obtain the new program code. This will ensure that program data will be maintained, assuring the user that all information is displayed identically on all units.

It is to be understood that the present disclosure may be implemented in various forms of hardware, software, firmware, special purpose processors, or a combination thereof. The IED 100 also includes an operating system and application programs. The various processes and functions described herein may either be part of an application program (or a combination thereof) which is executed via the operating system.

Because some of the system components and methods depicted in the accompanying figures may be implemented using either software or firmware, it is to be further understood that the actual connections between the system components (or the process steps) may differ depending on the specific way the present disclosure is programmed. Given the teachings of the present disclosure provided herein, one of ordinary skill in the related art will be able to contemplate these and similar implementations or configurations of the present disclosure.

Flicker is one of the important power quality values that the IED 100 can record. Flicker is the sensation experienced by the human visual system when it is subjected to fluctuations in the illumination intensity of a light source. The primary effects of flicker are headaches, irritability, and sometimes epileptic seizures. Flicker is a result of voltage variations that are caused by variable loads such as furnaces, laser printers, microwave ovens, or other power-consuming devices.

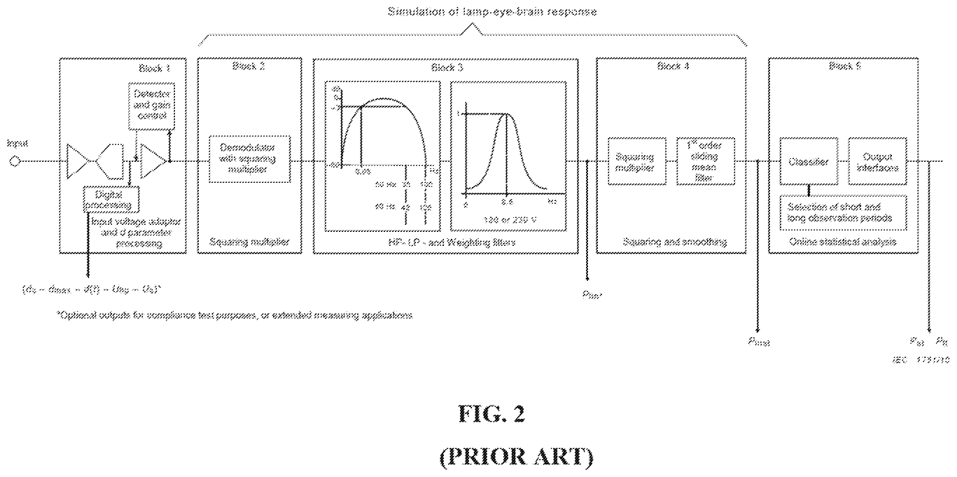

The function and design specification of flicker can be found in the standard IEC 61000-4-15. The block diagram of flicker is illustrated in FIG. 2. The main operation can be divided into two terms that consist of:
(i) simulation of the response of the lamp-eye-brain chain and
(ii) online statistical analysis of the flicker signal and presentation of results.

Block 1 of FIG. 2 includes an input voltage adaptor. In the adaptor, there is a voltage adapting circuit that can scale the mean RMS value (for “root mean square”) of the input fundamental frequency voltage down to an internal reference level such that the flicker measurement can be made independently of the actual input carrier voltage level and expressed as a percent ratio.

Block 2 is a quadratic demodulator unit that is designed to recover the light fluctuation by squaring the scaled input voltage to the reference level to simulate the behavior of an incandescent lamp. Since the incandescent lamp can be considered a resistive load, and the light intensity is strongly dependent on the energy consumed, the light produced by the incandescent lamp is proportional to the square of the input lamp voltage.

Block 3 includes a demodulator filter and weighting filter. The demodulator filter consists of a first-order, high-pass filter (3 dB cut-off frequency at 0.05 Hz) to eliminate the DC component caused by the squaring function in Block 2 and a low-pass, Butterworth filter of the sixth order with a 3 dB cut-off frequency of 35 Hz for 230V 50 Hz systems. The combined effect of these filters is to attenuate the DC components and all frequency components higher than the fundamental frequency. The weighting simulates the frequency response to fluctuations in a coiled filament gas-filled lamp (60 W, 230V or 120V) combined with the characteristics of the human visual system. The response function is based on the perceptibility threshold found at each frequency by 50% of the persons tested.

If the carrier suppression filter defined above has negligible influence inside the frequency bandwidth associated to voltage fluctuation signals, a suitable transfer function for Block 3 is described by the following:

$$F ( s ) = \frac{k {ω}_{1} s}{{s}^{2} + 2 λ s + {ω}_{1}^{2}} ⨯ \frac{1 + s / {ω}_{2}}{( 1 + s / {ω}_{3} ) ( 1 + s / {ω}_{4} )}$$

Where “s” is the Laplace complex, and indicative are given in Table 1 below.

TABLE 1

| variable | 230 V lamp | 120 V lamp |
|---|---|---|
| k | 1.74802 | 1.6357 |
| λ | 2π × 4.05981 | 2π × 4.167375 |
| ω₁ | 2π × 9.15494 | 2π × 9.077169 |
| ω₂ | 2π × 2.27979 | 2π × 2.939902 |
| ω₃ | 2π × 1.22535 | 2π × 1.394468 |
| ω₄ | 2π × 21.9 | 2π × 17.31512 |

Block 4 includes a squaring multiplier and an integrating function that is designed to simulate the storage effect of the human brain. This is implemented through a first-order, low-pass filter with a time constant equal to 300 ms (cut-off frequency is 0.53 Hz). The human eye-brain perception can be simulated through the non-linear responses of Block 2, 3, and 4. The output of Block 4 is defined as the instantaneous flicker level, Pᵢₙₛₜ.

Block 5 performs an online, statistical classification of the instantaneous flicker level, Pᵢₙₛₜ, and calculates the cumulative probability distribution of the amplitude of the instantaneous flicker sensation. Then, the short-term flicker index, Pₛₜ and long-term flicker index, Pᵢₜ, can be determined using statistical methods.

For the short-term flicker evaluation, the measure of severity based on an observation period, Tₛₕₒᵣₜ=10 minutes, is designated as Pₛₜ and is derived from the time-at-level statistics obtained from the level classifier in Block 5 of the flicker. Formula 1 is used to make the calculation:

$${P}_{st} = \sqrt{0.0314 {P}_{0.1} + 0.0525 {P}_{1 s} + 0.0657 {P}_{3 s} + 0.28 {P}_{10 s} + 0.08 {P}_{50 s}}$$

Where the percentiles P_{0.1}, P₁, P₃, P₁₀, P₅₀, are the flicker levels exceeded for 0.1%, 1%, 3%, 10%, and 50% of the time during an observation period. The suffix “s” in the formula indicates that smoothed values should be used; these are obtained using the following equations:

$${P}_{50 s} = \frac{{P}_{30} + {P}_{50} + {P}_{80}}{3}$$

$${P}_{10 s} = \frac{{P}_{6} + {P}_{8} + {P}_{10} + {P}_{13} + {P}_{17}}{3}$$

$${P}_{3 s} = \frac{{P}_{2.2} + {P}_{3} + {P}_{4}}{3}$$

$${P}_{1 s} = \frac{{P}_{0.7} + {P}_{1} + {P}_{1.5}}{3}$$

The long-term flicker severity (Pᵢₜ) shall be derived from the short-term severity values (Pₛₜ) over an appropriate period related to the duty cycle of the load or a period over which an observer may react to flicker. It can be determined by using the following formula:

$${P}_{lt} = \sqrt[3]{\frac{{\sum }_{i = 1}^{N} {P}_{sti}^{3}}{N}}$$

Where Pₛₜᵢ (i=1, 2, 3, . . . ) are consecutive readings of the short-term severity, Pₛₜ.

In one embodiment, the blocks can be implemented in DSP 105.

In prior art, after the instantaneous flicker level is obtained from Block 4, the Quicksort algorithm is executed in Block 5 to sort the instantaneous flicker level for 10 minutes-worth of data. The percentiles (such as P_{0.1}, P₁, P₃, P₁₀, P₅₀) are obtained from the sorted data. Then, the short-term flicker severity level is calculated with accordance with Formula 1. The Quicksort algorithm's average performance is O (n logⁿ). Under certain conditions, it can take several seconds to finish the sorting process and the performance is unsatisfactory.

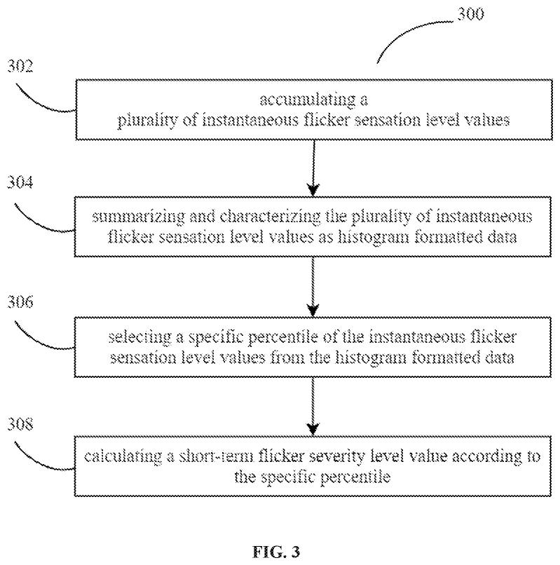

FIG. 3 illustrates a method 300 for estimating flicker severity in an electrical power distribution system. In the first step 302, the processing module of the IED 100, such as the DSP 105, accumulates a plurality of instantaneous flicker sensation level values. In one embodiment, the processing module accumulates the necessary 10 minutes-worth of instantaneous flicker sensation level values prior to execution of subsequent steps, although this may not always be necessary. In one embodiment, each of the instantaneous flicker sensation level values can be divided by the maximum value of the instantaneous flicker sensation level values to obtain normalized values. The normalized values will be processed in the next steps as updated instantaneous flicker sensation level values.

In step 304, the DSP 105 (or other processors, such as the CPU 109) summarizes and characterizes the plurality of instantaneous flicker sensation level values as histogram formatted data. Histogram formatted data is collected for the plurality of instantaneous flicker sensation level values which are generated by Block 4 in FIG. 2. The data is stored in memory (e.g., in the memory of the DSP 105). In one embodiment, the data stored in memory is 10 minutes-worth of instantaneous flicker sensation level values for the purpose of evaluating the short-term flicker severity level. Histogram formatted data is an approximate representation of the distribution of numerical data. To construct histogram formatted data, the first step is to “bin” (or “bucket”) the range of values—that is, divide the entire range of values into a series of intervals—and then count how many values fall into each interval. The bins are usually specified as consecutive, non-overlapping intervals of a variable. The bins (intervals) must be adjacent and are often (but not required to be) of equal size. The following table 2 illustrates an exemplary histogram formatted data.

TABLE 2

| | instantaneous flicker sensation level |
|---|---|
| bin | values falling into the bin |
| 1 | 50 |
| 2 | 60 |
| 3 | 75 |
| 4 | 80 |
| 5 | 100 |
| 6 | 90 |
| 7 | 35 |
| 8 | 48 |
| 9 | 72 |
| 10 | 10 |

In table 2, the instantaneous flicker sensation level values may range from 0 to 0.5. First the entire range of these instantaneous flicker sensation level values is divided into 10 intervals from bin 1 to bin 10. Then DSP 105 will count how many instantaneous flicker sensation level values fall into each interval.

In step 306, the DSP 105 (or other processors, such as the CPU 109) selects a specific percentile of the instantaneous flicker sensation level values from the histogram formatted data. The percentiles, P₁, P₃, P₁₀, P₅₀ are needed for evaluating the short-term flicker severity level. These percentiles can be selected by counting how many values fall into each interval in the histogram formatted data.

In step 308, the DSP 105 (or other processors, such as the CPU 109) calculates a short-term flicker severity level value according to the specific percentile. The short-term flicker severity level value can be calculated in accordance with Formula 1.

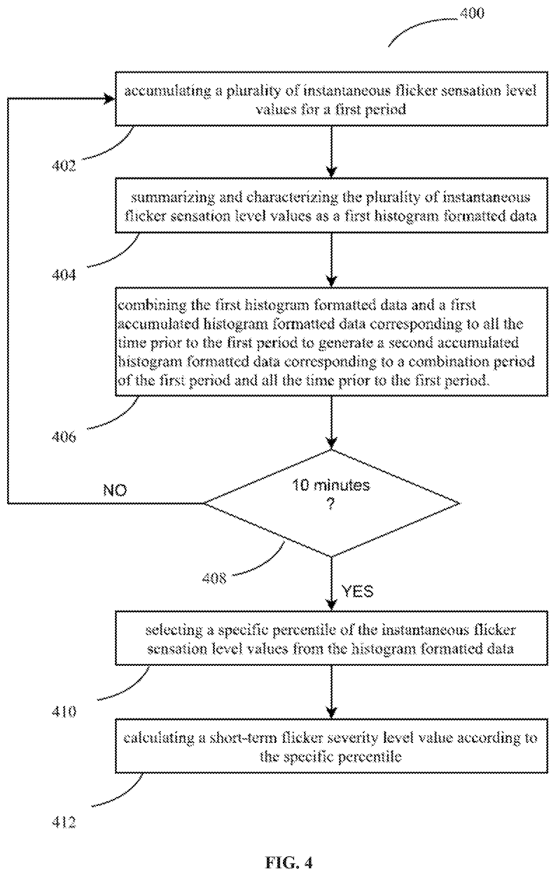

Turning now to FIG. 4 which illustrates a flowchart depicting an example method 400 according to embodiments of the present disclosure is discussed. The method begins at step 402 where the DSP 105 accumulates a plurality of instantaneous flicker sensation level values for a first period. For example, the DSP 105 starts to evaluate a short-term flicker severity level value at 00:00:00 where the time format is minute: second: millisecond. At 00:00:200, the DSP 105 stores the first 200 milliseconds of instantaneous flicker sensation level values in the memory. In one embodiment, each of the plurality of instantaneous flicker sensation level values can be divided by the maximum value of the plurality of instantaneous flicker sensation level values during the previous 10 minutes to obtain normalized values. The normalized values will be processed in the next steps as updated instantaneous flicker sensation level values. It should be noted that a short-term flicker severity level value is calculated based on the current 10 minutes of instantaneous flicker sensation level values. However, the maximum instantaneous flicker sensation level value from the previous 10 minutes can be easily obtained.

In step 404, the DSP 105 summarizes and characterizes the plurality of instantaneous flicker sensation level values as a first histogram formatted data. For example, the DSP 105 performs the first histogram operation to get the first histogram data at 00:00:200.

In Step 406, the DSP 105 combines the first histogram formatted data and a first accumulated histogram formatted data corresponding to all the time prior to the first period to generate a second, accumulated histogram formatted data that corresponds to a period that is the combination of the first period and all the time prior to the first period. For example, from 00:00:200 to 00:00:400, the DSP 105 continues to collect new data until the DSP 105 stores a second 200 milliseconds-worth of instantaneous flicker sensation level values in the memory. The DSP 105 performs the second histogram operation to get a second histogram data for the second 200 milliseconds-worth of instantaneous flicker sensation level values. Next, the DSP 105 combines the second histogram data with the first histogram data to obtain second accumulated histogram data which represents the distribution of instantaneous flicker sensation level values for the time between 00:00:00 and 00:00:400.

Next, from 00:00:400 to 00:00:600, the DSP 105 continues to collect new data until the DSP 105 stores third 200 milliseconds-worth of instantaneous flicker sensation level values in the memory. The DSP 105 performs the third histogram operation to get a third histogram for the third 200 milliseconds-worth of instantaneous flicker sensation level values. Then, the DSP 105 combines the third histogram with the second, accumulated histogram to obtain a third set of accumulated data which represents the distribution of instantaneous flicker sensation level values for the time between 00:00:00 and 00:00:600.

In Step 408, the DSP 105 determines whether the necessary 10 minutes-worth of instantaneous flicker sensation level values have been processed.

If it is prior to the 10-minute mark, the DSP continues to do the operations above. For example, from 00:00:600 to 00:00:800, the DSP 105 will continue to collect new data until the DSP 105 stores a fourth 200 milliseconds-worth of instantaneous flicker sensation level values in the memory. The DSP 105 perform the fourth histogram operation to get the fourth histogram data for the fourth 200 milliseconds-worth of instantaneous flicker sensation level values. Next, the DSP 105 combines the fourth histogram data with the third set of accumulated data to obtain the fourth set of accumulated data which represents the distribution of instantaneous flicker sensation level values for the time between 00:00:00 and 00:00:800.

In step 410, once the 10-minute mark is reached, the DSP 105 selects a specific percentile of the instantaneous flicker sensation level values from the histogram formatted data.

In step 410, the DSP 105 (or other processors, such as the CPU 109) selects a specific percentile of the instantaneous flicker sensation level values from 10 minutes-worth of histogram formatted data. The percentiles such that P_{0.1}, P₁, P₃, P₁₀, P₅₀ are needed for evaluating a short-term flicker severity level.

In step 412, the DSP 105 (or other processors, such as the CPU 109) calculates a short-term flicker severity level value according to the specific percentile. The short-term flicker severity level value can be calculated in accordance with Formula 1.

Both the short-term flicker severity level and the long-term flicker severity level value may be displayed on the LCD panel with touchscreen 113. When the short-term flicker severity level or the long-term flicker severity level value reaches a pre-determined threshold, the IED 100 will execute an e-mail client and will send notification e-mails to the utility or directly to the customer.

Flicker is generated by load changes. Only the amplitude of the load change is relevant, not the absolute value. A reduction in flicker can be attained through making less frequent load changes, or smaller load changes.

After the short-term flicker severity level or the long-term flicker severity level value is received by the technician, some load changes may be analyzed. The frequent load change will be suspended to reduce the flicker.

Embodiments of the teachings of the present disclosure have been described in an illustrative manner. It is to be understood that the terminology, which has been used, is intended to be in the nature of words of description rather than of limitation. Many modifications and variations of the embodiments are possible in light of the above teachings. Therefore, within the scope of the appended claims, the embodiments can be practiced other than specifically described.

What is claimed is:

1. An intelligent electronic device (IED) comprising:
at least one sensor configured for sensing at least one electrical parameter of electrical power distributed from an electrical distribution system to a load;
at least one analog-to-digital converter coupled to the at least one sensor and configured for converting an analog signal output from the at least one sensor to digital data;
at least one processing module coupled to the at least one analog-to-digital converter and to non-transitory memory storing instructions that when executed cause the at least one processing module to:
receive the digital data;
obtain a plurality of instantaneous flicker sensation level values based on the digital data;
summarize and characterize a plurality of instantaneous flicker sensation level values as histogram formatted data;
select a specific percentile of the instantaneous flicker sensation level values from the histogram formatted data; and
calculate a short-term flicker severity level value according to the specific percentile.

2. The IED of claim 1, wherein the plurality of instantaneous flicker sensation level values are normalized values.

3. The IED of claim 2, wherein the normalized values are obtained according to the maximum value of original instantaneous flicker sensation level values in a period of ten minutes.

4. The IED of claim 1, wherein the plurality of instantaneous flicker sensation level values is a set of values collected over a period of ten minutes.

5. The IED of claim 1, wherein summarize and characterize a plurality of instantaneous flicker sensation level values as histogram formatted data include:
summarize and characterize a first set of instantaneous flicker sensation level values for a first period as a first histogram formatted data;
combine the first histogram formatted data and a first accumulated histogram formatted data corresponding to all the time prior to the first period to generate a second, accumulated histogram formatted data corresponding to a combination of the first period and all the time prior to the first period.

6. The IED of claim 1, wherein the specific percentile is one of flicker levels exceeded for 0.1%, 1%, 3%, 10%, 50% of the time during a observation period.

7. The IED of claim 1, wherein the at least one processing module is further configured to:
calculate a long-term flicker severity level value based on a plurality of the short-term flicker severity level values.

8. A method for estimating a flicker severity in an electrical power distribution system, the method comprising:
accumulating a plurality of instantaneous flicker sensation level values;
summarizing and characterizing the plurality of instantaneous flicker sensation level values as histogram formatted data;
selecting a specific percentile of the instantaneous flicker sensation level values from the histogram formatted data;
calculating a short-term flicker severity level value according to the specific percentile.

9. The method of claim 8, wherein the plurality of instantaneous flicker sensation level values are normalized values.

10. The method of claim 9, wherein the normalized values are obtained according to the maximum value of original instantaneous flicker sensation level values in a period of ten minutes.

11. The method of claim 8, wherein the plurality of instantaneous flicker sensation level values are a set of values collected in a period of ten minutes.

12. The method of claim 8, wherein the summarizing and characterizing a plurality of instantaneous flicker sensation level values as histogram formatted data includes:
summarizing and characterizing a first set of instantaneous flicker sensation level values for a first period as a first histogram formatted data;
combining the first histogram formatted data and a first accumulated histogram formatted data corresponding to all the time prior to the first period to generate a second accumulated histogram formatted data corresponding to a combination period of the first period and all the time prior to the first period.

13. The method of claim 8, wherein the specific percentile is one of flicker levels exceeded for 0.1%, 1%, 3%, 10%, or 50% of the time during an observation period.

14. The method of claim 8, further comprising:
calculating a long-term flicker severity level value based on a plurality of the short-term flicker severity level values.
